(19) United States
(12) Patent Application Publication
(10) Pub. No.: US 2009/0153747 A1
(43) Pub. Date: Jun. 18, 2009

(54) Pre-Processing of Descrambling Data to Reduce Channel-Change Time

(75) Inventor: Kevin Lloyd Grimes, Fishers, IN (US)

Correspondence Address: Thomson Licensing LLC, P.O. Box 5312, Two Independence Way, PRINCETON, NJ, 08543-5312, US

(73) Assignee: THOMASON LICENSING S.A., Boulogne Cedex (FR)

(21) Appl. No.: 10/568,003

(22) PCT Filed: Jan. 20, 2004
(86) PCT No.: PCT/US04/01573

§ 371 Date: Feb. 4, 2008

Related U.S. Application Data
(60) Provisional application No. 60/494,835, filed on Aug. 13, 2003.

(51) Int. Cl. H04N 5/50

(52) U.S. Cl. 348/731; 348/E05.097

(57) ABSTRACT

This invention discloses an apparatus and a method for receiving a plurality of encrypted digital video, audio and data that require an encryption key to decode before utilizing. Specifically the invention is directed toward devices such as cable and digital broadcast satellite systems that transmit multiple channel information to receivers that provide users access to the multiple channels upon particular channel selection. Such channel selection requires decrypting and formatting a new data stream through a time consuming electronic process. The invention described herein reduces channel change time, by monitoring de-scrambled data in the background, prior to a user selecting a new channel. Digital broadcast data contain input de-scrambling control words required for the decoding of N-bit de-scrambling keys for each of a multiplicity of digital data streams available. Storing the data control words or the N-bit descramble keys reduces subsequent retrieval decoding time. However, utilizing the control words to descramble the N-bit de-scrambling keys and then storing the N-bit de-scrambling keys, typically yields the greatest gain in reducing channel change time.

### BACKGROUND OF THE INVENTION

1. Field of the Invention

The invention relates generally to a method and an apparatus for receiving and processing multi-channel digital video/audio/data (“digital data”) transmissions, and more generally to digital broadcast receivers capable of providing quicker response to a user's command to change channels.

2. Description of Related Art

The time required for a multi-channel digital video receiver to change channels is greater than the time to change channels in an analog video system. In either system, reception processing for a selected channel requires a tuner to tune to the desired carrier frequency, select the desired packets, and demodulate the signal. A digital broadcast signal typically requires additional steps such as, to decode the typically descrambled information, decompress MPEG encoding data, provide error correction and transporting the resulting data packets to a digital decoder before the desired program can be displayed. In a high-capacity, multiple-channel direct broadcast satellite system, receivers may require several tenths of a second ranging from one to five seconds, to change channels depending on hardware and software implementation, and bit rates of the digital data transmission. However, at least part of the time delay results from the convention to descramble digital data and form a video presentation sequentially. U.S. Pat. No. 5,933,192, U.S. Pat. No. 6,118,498 disclose two examples of apparatuses and methods to reduce channel change time.

Current digital video decoder systems decode encrypted digital data streams (see FIG. 1, Prior Art). These systems are well known to those skilled in the art of digital broadcasts such as by way of example cable and digital broadcast satellite (“DBS”) systems, and include tuners, de-modulators, decoders, transport de-multiplexers, microprocessors, program memories, video picture memories, MPEG video decoders, displays, and smart cards.

In the prior art, scrambled data are transmitted together with associated control words for descrambling of the data, the control words being encrypted by a exploitation key and transmitted in encrypted form. The scrambled data and associated control word are then received by a decoder having access to an equivalent of the exploitation key stored on a smart card that is inserted into the receiver to decrypt the encrypted control word and thereafter generate an N-bit descrambling key to decode the transmitted digital data. For example, in a paid-up digital broadcast system, the subscriber receives an entitlement control message which constitutes the exploitation key necessary to decrypt the encrypted control word necessary to decode a 56-bit descrambling key so as to permit viewing of the transmission.

When the user selects a channel, the software configures the transport de-multiplexer with a program identification (PID) that then filters the incoming digital data packets. The system then enables the flow of transport data stream to the PID compare block which inspects every packet in the digital data stream and compares the data packets to a list of entries in a look-up table. Typically, if a match exists, then the data packet is sent to the descrambler. Most digital broadcast system data streams and most digital cable data streams are scrambled for security purposes. Digital broadcast system descrambling is achieved by transmitting and receiving a control word packet that contains decryption specifications in the form of input data. Decryption control words are processed by algorithms programmed into the smart card, which generate an N-bit de-scrambling key. Current systems typically utilize keys as large as 56-bits. The N-bit keys are then stored in transport registers for data encryption scrambling. Once descrambling occurs, the system builds a video composite picture in memory, typically in accordance with the MPEG-2 standard, and displays the desired picture on a display. When the user changes channels, the system disables the current decoding activity and restarts the entire sequence described above with the parameters of the new channel. If there are errors in the signal, as for example, due to weather or poor signal reception, then the user must wait an additional delay time to change channels.

### SUMMARY OF THE INVENTION

The delays associated with channel acquisition are particularly annoying to a television user who is sequentially scrolling through adjacent channels, an operation that many users prefer to perform quickly. In part the delay is due to the encrypted digital content, which requires a decoder to process de-scrambling data in specific sequential steps. This invention focuses on the transport de-multiplexer and smart card to reduce the user channel change time by decoding the control word associated with the descrambling key or the descrambling key itself for each of the next predicted channels that is prior to the user selecting a new channel.

The invention disclosed herein includes a digital video transmission receiver comprising: a tuning and decoding means for tuning and decoding a digital transmission to produce a set of N-bit descrambling keys associated with two or more tuned channels; a programmed microprocessor to respond to a user's request for a selected one of the two or more tuned channels by causing the set of descrambling keys for the selected channel to be outputted, to descramble digital transport streams required to format digital information into a video display.

In a further embodiment the digital video transmission receiver unit comprises an apparatus that stores a control word. This includes a tuning and a decoding means for tuning and decoding a digital transmission to produce a set of control words related to two or more tuned channels each associated with an N-bit descrambling key; and a programmed microprocessor to respond to a user's request for a selected one of the two or more tuned channels by causing one of the control words within the set of control words to generate a descrambling key for the selected channel to be outputted, to descramble digital transport streams required to format digital information into a video display.

### BRIEF DESCRIPTION OF THE DRAWINGS

The invention is best understood from the following detailed description when read in connection with the accompanying drawing. The various features of the drawings are not exhaustively specified. On the contrary, the various features may arbitrarily be expanded or reduced for clarity. Included in the drawing are the following figures:

FIG. 1 is a block diagram of a prior art receiving unit.

FIG. 2 is a block diagram of the invention.

FIG. 3 is a method of reducing the delay in channel selection utilizing stored N-bit decoded keys.

FIG. 4 is a method of reducing the delay in channel selection utilizing control words.

### DETAILED DESCRIPTION OF THE INVENTION

This invention discloses an apparatus and a method that stores the digital data input de-scrambling control words required for the decoding of a descrambling key or the resulting N-bit de-scrambling keys themselves, for a multiplicity of digital data transport streams. Storing the data control words will reduce subsequent retrieval time, when the control words are required to descramble the associated scrambled keys that decode a digital data stream. However, utilizing the control words to descramble the N-bit de-scrambling keys and then storing the N-bit de-scrambling keys typically yields the greatest gain in reducing channel change time. Concurrent monitoring of multiple programs can be performed by adding multiple program identification or PIDs to a PID-table.

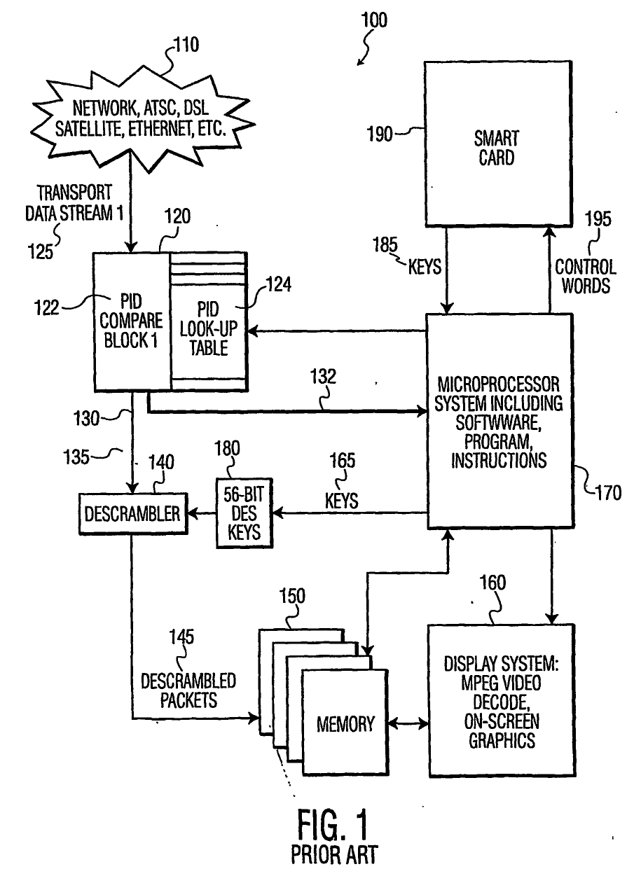

Referring to FIG. 1, a broadcast system 110 provides scrambled digital information to a receiver 100, which requires unscrambling prior to assembling a frame of data that can be perceived by a user. A video, audio and data broadcast system 110 provides a stream of data 125 that includes data packets 131 received by a receiver input to a PID compare block 122 that compares each data packet 131 in the data stream 125 to a preexisting entry in a PID look up table 124. Finding a match between the incoming data packet 131 and the preexisting entry, an output data packet 130 is passed to a descrambler 140. Within the data packet 130, a control word 132 provides decryption input data, the information necessary to decrypt the descrambling keys that subsequently decode the input data video, audio and data stream. The decryption input data control word 132 is provided to a smart card 190 typically through a microprocessor 170 that utilizes the information therein contained to generate an N-bit descrambling key 185, typically a 56-bit decoding key. The descrambling key 185 is stored in a transport register 180, where the key is used in deciphering scrambled video, audio and data required for user perception. In a typical video system, the descrambled packets 145 are used to construct a video frame in memory 150 in accordance with a preexisting standard, such as MPEG-2. Thereafter a video display 160 permits the programs to be viewed.

When the user changes channels, the receiver system 100 must disable itself and restart the above sequence of acquiring a data packets 131 for input to the PID compare block 122 that compares each data packet 131 in the data stream 125 to a preexisting entry in a PID look up table 124. When a match occurs, the control word 132 that provides decryption input data, is relayed to the microprocessor 170 and smart card 190 for the ultimate generation of a 56-bit key for subsequent descrambling of the new channel.

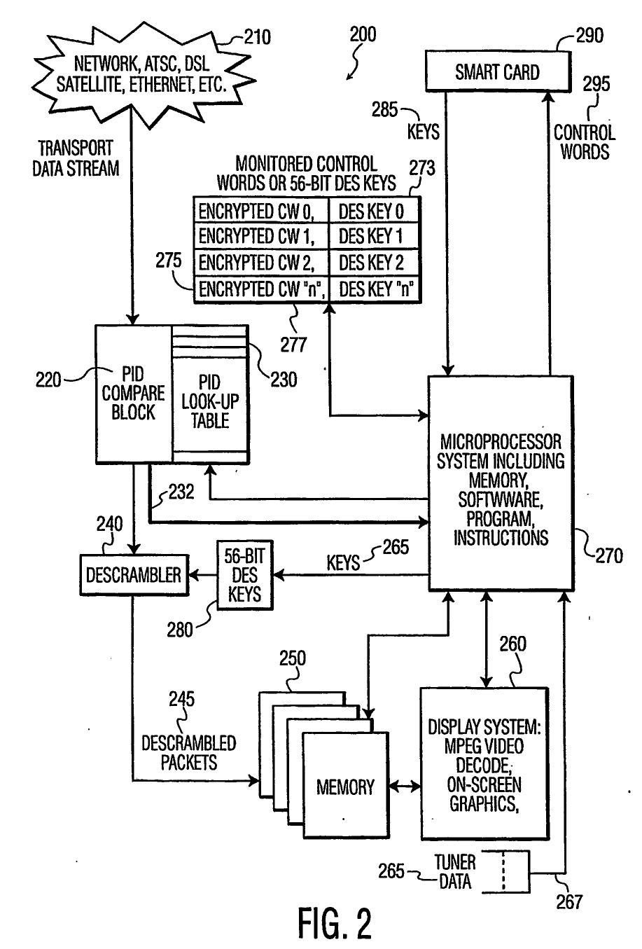

Referring to FIG. 2, when a user of the broadcast system 210 initiates a channel change, the receiver system 200 needs only to switch the N-bit stored de-scrambling key for the current digital data stream associated with a desired program. The N-bit de-scrambling key, previously decoded in the background, or simultaneously therewith the digital data processing stream, permits the rapid de-scrambling of any newly selected digital data channel. When the invention is applied to current technology, this method of channel change can realize as much as a 40% reduction in the channel selection delay time.

FIG. 2 illustrates the invention, wherein a digital receiver 200 receives a broadcast transmission 205 that produces a set of N-bit descrambling keys 273 associated with two or more tuned channels 265, utilizing a programmed means 270 to respond to a user's request for a selected one of the two or more tuned channels, by causing the set of descrambling keys 273 for the selected channel to be outputted in accordance with the associated descrambled digital transport streams 245 required to format digital information so as to be perceived by a user. Typically, such perception is achieved when a selected video display 260 projects a picture onto a cathode ray tube or other such two dimensional video display.

The monitoring and decoding as described can be achieved through the storage of the input de-scrambling data control words 294, which at a future time will be utilized in the generation of a N-bit descrambling key, or through the immediate generation of 56-bit keys in a memory 275. Storing the 56-bit keys yields the greatest gain in reduced channel change time, since the steps requiring the control word as input to the appropriate program to create the N-bit key will already have been accomplished when they are required. Since there are multiple simultaneous scrambling data packets, each is stored in a different location in memory 275. Simultaneous monitoring of multiple programs can be performed by adding multiple program PID to the PID-table 230.

The invention reduces the user channel change time, by monitoring the control words 295 as derived from a predicted next user channel as by way of example described in U.S. Pat. No. 5,933,192 or U.S. Pat. No. 6,118,498. Optionally, all the channels in the broadcast system 210 may be monitored utilizing technology well known by those who are skilled in the art of developing satellite receiving systems. By processing all the descrambling keys in advance of the desired received program, the receiving system 200 can monitor all the channels existing on a transponder. Thus when the user changes channels, tuner data 265 can cause the immediate decoding of scrambled digital data, since the decryption input keys were previously received, and passed to the smart card 290 resulting in a set of output keys 277 stored in memory a memory 275.

The invention as herein described can, in a typical receiver system, reduce the processing time in the order of magnitude of 400 milliseconds in the completion of a user initiated channel change.

The de-scrambling input data in the stream is repeated in the data stream at a periodic rate. By way of example, in one commercial system this rate is a maximum 200 milliseconds. The smart card 290 is typically allowed up to 150 milliseconds to generate the 56-bit key 285. The decoder system is allowed up to 50 milliseconds to respond to the smart card, 290 and move the 56-bit key 285 to the transport register 280 and commence decoding of live transport data streams 245

All 3 steps are required sequentially, for each channel change.

When the user initiates a channel change, the system needs only to switch via tuner data 265 from the current program, to the background decoded 56-bit keys in memory 277. Utilizing programming methods well known to those skilled in the art of programming, many 56-bit keys are accessibly stored in memory 275.

In the prior art, only one video stream is generally displayed at a time, the notable exception being picture-in-picture (PIP) or similar systems. PIP systems allow for simultaneous display of more than one picture. However, few digital PIP systems exist in the market today. Predictive decode and monitoring of descrambling data could can be employed in conjunction with digital PIP. Furthermore, this invention would make digital PIP features faster, because the secondary channel is already being monitored and decoded, before the user chooses to display a second picture. Systems with or without PIP will benefit from this invention.

The invention herein disclosed includes a method of: descrambling an input data stream so that the smart card 290 utilizing the control word 295 input generates an N-bit data encryption decode key to permit the subsequent descrambling of digital data. Once the descrambling key 285 has been generated, it is stored in memory 273 and made immediately available as an N-bit key, as for example, to the 56 bit key 280 and the transport 240, so as to decode transport data into descrambled digital data 245. Each time a channel is changed, the process repeats the forgoing steps.

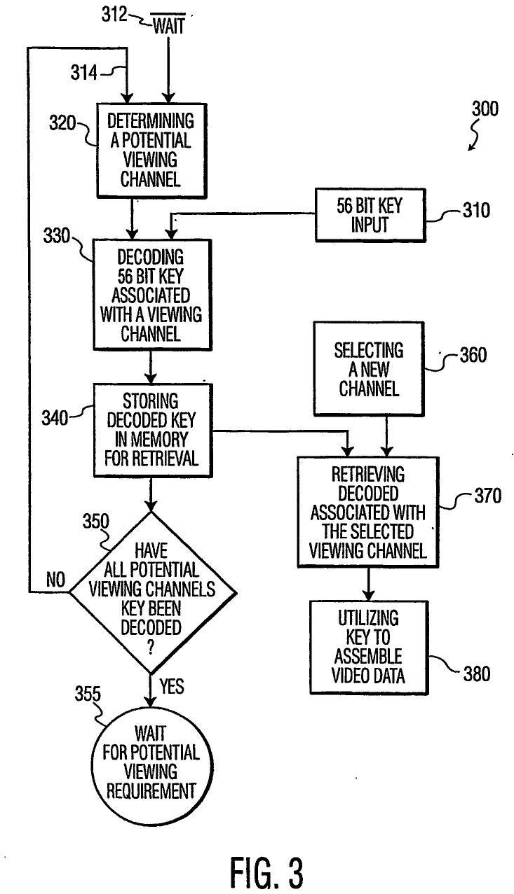

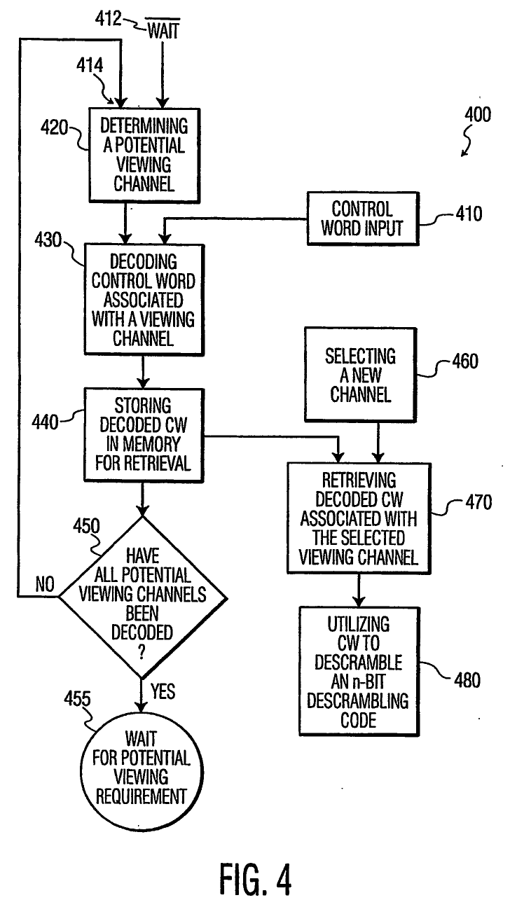

More particularly with reference to FIG. 3 and FIG. 4, there are as many potential channel changes as there are channels broadcast by the digital broadcast system 210. However, each receiver system 200 may only utilize a subset of the universe of potential changes possible. Presuming such a potential change exists, then referring to FIG. 3, the system 300 will not be in a wait state 312 and the receiver system 200 will initiate the step of determining a potential viewing channel 320. Thereafter, a 56 bit key (56 used for illustration only), associated with the viewing channel is decoded 330 and stored 340 in a memory, retrievable in the event the potential viewing channel is selected by the user. When a channel has been selected 360 by the user, the decoded key associated with the selected viewing channel is retrieved 370 and utilized 380 to descramble an N-bit descrambling code 380. The descrambling key is then used to assemble 390 a digital data stream into a means perceivable by the viewer. Once a descrambling key is decoded, the system 300 determines if all channels having the potential for viewing have had their descrambling keys decoded 330. If they have had their keys decoded 330, then the system 300 simply waits 355 for a new viewing potential 355. If the viewing potential 355 has not been exhausted than the decision 350 reverts the process to step 314 to begin the process of decoding 330 a new descrambling key. In time-varying broadcast security schemes, the decision 350 must continually monitor the network data packets 220 to determine when new control words are applied to the predicted channel broadcast transmission 205.

Again, presuming a potential change exists, then referring to FIG. 4, the system 400 will not be in a wait state 412 and the system will initiate the step of determining a potential viewing channel 420. Thereafter, a control word, associated with a descrambling N-bit descrambling code and associated the viewing channel is decoded 430 and stored 440 in a memory, retrievable in the event the potential viewing channel is selected by the user. When a channel has been selected 460 by the user, the control word is retrieved 470 and utilized to descramble an N-bit descrambling code 480. The descrambling key is they utilized 480 to assemble a digital data stream into a means perceivable by the viewer. Once a control word is decoded 430, the system 400 determines if all channels having the potential for viewing 450 have had their control words 410 stored. If they have had their keys stored 440, then the system waits 455 for a new viewing potential 455. If the viewing potential has not been exhausted than the decision 450 reverts the process to step 420 to begin the process of storing a new control word 440. In time-varying broadcast security schemes, the decision 450 must continually monitor the network data packets 220 to determine when new control words are applied to the predicted channel broadcast transmission 205.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

What is claimed is:

1. A receiver comprising:
two or more tuned channels, utilizing a programmed means to respond to a user's request for a selected one of the two or more tuned channels by causing one of a set of descrambling keys for the selected channel to be outputted, in accordance with the associated descrambled digital transport streams required to format information into a selected video display.

2. The receiver in claim 1, wherein the set of descrambling keys are stored in a memory.

3. The receiver in claim 1, wherein the set of descrambling keys are compared, in a program selection mode of operation, to identify a desired digital transport stream.

4. The receiver in claim 2, wherein the set of descrambling keys are retrieved from the memory, responsive to selected one of the two or more tuned channels.

5. A receiver comprising:
a tuning and a decoding unit for tuning and decoding a digital transmission to produce a set of control words related to two or more tuned channels each associated with a descrambling key;
a programmed means to respond to a user's request for a selected one of the two or more tuned channels by causing one of the control words within the set of control words to generate a descrambling key for the selected channel to be outputted, to descramble digital transport streams required to format digital information into a video display.

6. The receiver in claim 5, wherein the set of control words are stored in a memory.

7. The receiver in claim 5, wherein the set of control words are compared, in a program selection mode of operation, to identify a desired digital descrambling key stream.

8. The receiver in claim 6, wherein the set of control words are retrieved, from the memory, the stored portion of the control words comparing favorably to the descrambling key means associated with the desired digital transport stream.

9. A method of video transmission reception comprising:
tuning and decoding a digital transmission to produce a set of descrambling keys associated with two or more tuned channels; and
programming a means to respond to a user's request for a selected one of the two or more tuned channels by causing the set of descrambling keys for the selected channel to be outputted, to descramble digital transport streams required to format digital information into a video display.

10. The method of reception in claim 9, further comprising storing the set of descrambling keys in a memory.

11. The method of reception in claim 9 further comprising comparing the set of descrambling keys in a program selection mode of operation, to identify a desired digital transport stream.

12. The method of reception in claim 10, further comprising retrieving the set of descrambling keys from the memory, the stored portion of the descrambling keys comparing favorably to the desired digital transport stream.

13. A method of reception comprising:
tuning and decoding a digital transmission to produce a set of control words related to two or more tuned channels each associated with an descrambling key; and
programming a means to respond to a user's request for a selected one of the two or more tuned channels by causing one of the control words within the set of control words to generate a descrambling key for the selected channel to be outputted, to descramble digital transport streams required to format digital information into a video display.

14. The method of reception in claim 13, further comprising storing the set of control words in a memory.

15. The method of reception in claim 13, further comprising comparing the set of control words in a program selection mode of operation, to identify a desired digital transport stream.

16. The method of reception in claim 14, further comprising retrieving the set of control words from the memory, the stored portion of the control words comparing favorably to the desired descrambling key.

17. A method of reception comprising the steps of:
determining a potential viewing channel; decoding a decoding key associated with the potential viewing channel; storing the decoding key in a memory retrievable in the event the potential viewing channel is selected by a user; determining if all channels having the potential for viewing have had the respective descrambling keys decoded and if all channels having the potential for viewing have not had the respective descrambling keys decoded then continuing to monitor a digital transmission for a new control word, as required in time-varying broadcast.

18. The method of reception in claim 17, further comprising the step of retrieving the descrambling key associated with a selected viewing channel.

19. The method of reception in claim 18, further comprising the step of utilizing the descrambling key associated with a selected viewing channel to assemble digital data.

20. A method of reception comprising the steps of:
determining a potential viewing channel; decoding a control word associated with the potential viewing channel; storing the control word in a memory retrievable in the event the potential viewing channel is selected by a user; determining if all channels having the potential for viewing have had the control word decoded and if all channels having the potential for viewing have not had the respective control word decoded then continuing to monitor a digital transmission for a new control word, as required in time-varying broadcast.

21. The method of reception in claim 20, further comprising the step of retrieving the control word to descramble a key associated with a selected viewing channel.

22. The method of reception in claim 21, further comprising the step of utilizing the control word to descrambling a key associated with a selected viewing channel to assemble digital data.
